(19) United States
(12) Patent Application Publication
(10) Pub. No.: US 2006/0283383 A1
(43) Pub. Date: Dec. 21, 2006

(54) Method for rehabilitating existing pipeline

(76) Inventors: Yoshiharu Nozaki, Kyoto (JP); Hiroshi Sugahara, Shiga (JP); Akihiko Takaya, Shiga (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/406,410

(22) Filed: Apr. 19, 2006

(30) Foreign Application Priority Data
Aug. 5, 2004 (JP) 2004-229649
Mar. 31, 2004 (JP) 2004-107559
Feb. 22, 2006 (JP) 2006-045586
Feb. 22, 2006 (JP) 2006-045587

(51) Int. Cl. B05C 1/00

(52) U.S. Cl. 118/254; 366/2; 138/97

(57) ABSTRACT

Slurry A is kneaded at ground level to produce a high-flow low-viscosity mortar, whereupon the kneaded Slurry A is pressure fed by a Slurry A pump via a Slurry A hose to a fixed volume dispensing section. Simultaneously, kneaded Slurry B is pressure fed by a Slurry B pump via a Slurry B hose to a kneading section. Slurry A supplied to the fixed volume dispensing section is then more uniformly kneaded there and, by adding Slurry B, i.e. the additive, in the subsequent kneading section and kneading Slurry A with Slurry B in a fixed proportion, a high-viscosity mortar is produced, with said high-viscosity mortar injected into a space between an existing pipeline and a spiral wound pipe through an injection nozzle of a supply hose.

### BACKGROUND OF THE INVENTION

The present invention relates to a method for rehabilitating an existing pipeline, in which a pipe is fabricated with the help of a pipe fabrication machine on the interior surface of a pipeline (called “existing pipeline” below) from an elongated strip having interlocking sections formed along its two lateral margins by spirally interlocking the interlocking sections while injecting mortar into the space between the existing pipeline and the newly formed spiral wound pipe, and, more specifically, relates to a method for grouting with mortar during rehabilitation of an existing pipeline.

In the past, existing pipelines were rehabilitated using a method called “liner pipe fabrication with simultaneous grouting” (for instance, see JP 2003-42345A), i.e. a method for rehabilitating existing pipelines in which, as shown in FIG. 10 and FIG. 11, a pipe fabrication machine 11 installed inside an existing pipeline 10 was used to spirally wind and interlock a flexible band-like profile strip 13a having interlocking sections formed along its two lateral margins, molding it into a spiral wound pipe 13 (rehabilitation pipe) and introducing it in an existing pipeline 10, while, at the same time, filling the space 12 between the existing pipeline 10 and the newly installed spiral wound pipe 13 by injecting mortar serving as a filler.

In such a case, when the space 12 between the existing pipeline 10 and the spiral wound pipe 13 was filled by injecting mortar serving as a filler, an injection nozzle 14a of a supply hose 14 used for supplying the mortar filler was inserted into the space 12 between the existing pipeline 10 and the spiral wound pipe 13 through one end of the spiral wound pipe 13 inserted into the existing pipeline 10 and the space was filled by injecting the mortar.

Incidentally, the following properties are required of the mortar supplied under this method.

It has to possess sufficiently high viscosity to prevent the mortar from slumping by virtue of its own weight in the space between the existing pipeline and the newly installed spiral wound pipe.

This results from the fact that when mortar slumps in this manner, especially when the pipe fabrication machine faces downward, the mortar drops down, resulting in a rehabilitation pipe with an unfilled the space.

It has to be viscous to an extent that would allow it to be discharged by a pump used for filling the space by injection.

This is due to the fact that filling the space is impossible if it cannot be discharged by a pump.

It needs to have stable viscosity.

This is due to the fact that the volume of pump discharge used for filling the space by injection becomes unstable in case of fluctuations in mortar viscosity. Namely, if the viscosity of the mortar is low, the space of the resultant rehabilitation pipe is not filled because the mortar slumps in the space by virtue of its own weight; otherwise, problems may arise when the mortar overflows from the space because of an increase in the discharge volume of the mortar discharged from the pump, resulting either in soiling the interior surface of the pipe, or in adhesion to and curing on the pipe fabrication machine, which renders the pipe fabrication machine impossible to operate, etc. Conversely, when the viscosity of the mortar increases, the discharge volume of the mortar discharged from the pump decreases, producing a rehabilitation pipe with an unfilled the space.

Consequently, in the past, mortar used to be supplied by kneading it in batch units of about 20 kg, which permitted easy manual metering control, transporting it manually through the existing pipeline 10 in such batch units, charging it into a pump (not shown) installed in the vicinity of the pipe fabrication machine 11 in the existing pipeline 10, and filling the space 12 with the mortar by injecting it through the supply hose 14.

Thus, in the past, mortar serving as a filler was kneaded e.g. in a small batch kneader (not shown) installed at ground level, and operators transported the kneaded mortar to the pipe fabrication machine by entering the existing pipeline. This was due to the fact that, for instance, even if the mortar was pressure fed through piping (a hose) from ground level to the pump installed in the vicinity of the pipe fabrication machine, the high viscosity of the mortar allowed it to be used only over short distances and made it impossible to supply over large distances. For this reason, the mortar grouting method presented problems in terms of the required labor and man-hour. Furthermore, small-diameter pipelines were difficult to rehabilitate because they did not allow for man-entry.

### SUMMARY OF THE INVENTION

The present invention was conceived in order to address such problems and its object is to provide a method for rehabilitating an existing pipeline which, along with achieving a man-hour reduction and labor savings, provides for stable mortar injection even in case of significant elevation differences between ground level and existing pipelines by eliminating manual transportation and permitting pressurized supply through a hose.

The inventive method for rehabilitating an existing pipeline is an existing pipeline rehabilitation method consisting in fabricating a pipe on the interior surface of a pipeline from an elongated strip having interlocking sections formed along its two lateral margins by spirally interlocking the interlocking sections with the help of a pipe fabrication machine while injecting high-viscosity mortar into a space between the pipeline and the newly formed spiral wound pipe, wherein a pump equipped with a kneading section is installed inside the pipeline and, along with supplying low-viscosity mortar through piping from ground level to the pump equipped with the kneading section, a viscosity-increasing additive is supplied to the kneading section, thereby producing a high-viscosity mortar, with the high-viscosity mortar injected into the space by the pump equipped with the kneading section.

According to the inventive method for rehabilitating an existing pipeline, the low-viscosity mortar is pressure fed through piping from ground level to the pipe fabrication machine and is injected into the space after being turned into a high-viscosity mortar by kneading the low-viscosity mortar with the viscosity-increasing additive prior to injection into the space between the pipeline and the spiral wound pipe, as a result of which a fixed volume of the high-viscosity mortar can be reliably injected into the space even in case of a large distance between ground level and the pipe fabrication machine. In addition, the fact that manual transportation is rendered unnecessary allows for a man-hour reduction and labor savings. Furthermore, the method permits rehabilitation of small-diameter non-man-entry pipelines.

The method for rehabilitating an existing pipeline described above may be adapted to supply the additive from ground level to the kneading section through piping designed specifically for the additive.

In the inventive method for rehabilitating an existing pipeline, the pump equipped with the kneading section may be adapted to have a zone used for extruding a fixed volume of the low-viscosity mortar, and a zone provided with an intake port for supplying the additive, in which the low-viscosity mortar is kneaded with the additive.

In the inventive method for rehabilitating an existing pipeline, the pump equipped with the kneading section may be designed to have a zone, in which low-viscosity mortar is kneaded with the additive, and a zone, in which the kneaded high-viscosity mortar is pressure fed forward.

In the inventive method for rehabilitating an existing pipeline, the pump equipped with the kneading section may be designed to have a zone, in which the low-viscosity mortar and the additive are fed forward while being kneaded, and a zone, in which the high-viscosity mortar discharged from the preceding zone is sucked in and then pressure fed forward.

In the inventive method for rehabilitating an existing pipeline, the flow value of the low-viscosity mortar is preferably not less than 200 mm and the flow value of the high-viscosity mortar obtained after the addition of the additive is less than 200 mm. Here, the flow value was measured in accordance with JIS R 5201, with the exception of using no tamping or dropping for low-viscosity mortar and no dropping for high-viscosity mortar.

The low-viscosity mortar is produced by compounding appropriate amounts of raw materials such as cement (Portland cements such as ordinary Portland cement, high early strength Portland cement, ultra high-early-strength Portland cement, and moderate heat Portland cement, etc., blended cements such as blast furnace cement, silica cement, etc.) and water as essential components, and, in addition,
admixtures (flyash, blast-furnace slag, silica fumes, etc.);
expansion materials (CaO, 3CaO.Al₂O₃.CaSO₄, and 6CaO.Al₂O₃.S₃, etc.);
expansion agents (aluminum powder, silicon powder, etc.);
water-reducing agents (ligninsulfonic acid, naphthalenesulfonic acid, melaminesulfonic acid, polycarboxylic acid, and aminosulfonic acid-based, etc);
segregation-reducing agents (methylcellulose, polyvinyl alcohol, hydroxyl alcohol, sodium polyacrylate, and polyacrylamide-based);
aggregates (silica sand, river sand, stone powder, etc.); and
polymer dispersions (acrylic, vinyl acetate, ethylene/vinyl acetate, and SBR-based, etc.)
   in such a manner that the flow value is not less than 200 mm.

For instance, a combination of 100 parts by weight of ordinary Portland cement, 1.5 parts by weight of 3CaO Al₂O₃ CaSO₄, 0.0023 parts by weight of aluminum powder, 1 part by weight of a polycarboxylic acid-based water-reducing agent, and 47 parts by weight of water, which is a low-viscosity mortar of high flowability with a flow value of 330 mm, can be suggested as an example of the low-viscosity mortar.

The additive is obtained by dispersing a clay mineral in water using a dispersing agent. Clay minerals such as bentonite, metakaolin, and attapulgite can be used as the clay mineral.

Dispersing agents, including:
inorganic phosphates, such as sodium tripolyphosphate, sodium tetrapolyphosphate, and sodium pyrophosphate;
carboxylic acid salts of aliphatic compounds and cyclic compounds;
sulfonated oils, alkyl sulfates, alkyl ether sulfates, alkyl ester sulfates, and other aliphatic sulfuric acid esters, as well as alkyl aryl ether sulfates and other sulfuric ester salts of cyclic compounds;
alkyl sulfonates, sulfosuccinates, and other aliphatic sulfonates, as well as alkyl aryl and alkyl naphthalenesulfonates and other sulfonic acid salts of cyclic compounds; and
alkyl phosphates, ether phosphates, and other aliphatic phosphoric acid ester salts, as well as alkyl aryl ether phosphates and other phosphoric acid ester salts can be used as the dispersing agent.

The formulation of the additive is designed to produce an additive with a flow value of not less than 200 mm, similar to the low-viscosity mortar.

For example, a combination of 35 parts by weight of metakaolin, 0.7 parts by weight of sodium pyrophosphate, and 100 parts by weight of water, which is a low viscosity additive with a flow value of 360 mm, can be suggested as an example of the additive mixture.

In addition, as another example of the additive, one may suggest, for instance, a combination of 40 parts by weight of attapulgite, 0.3 parts by weight of sodium tripolyphosphate, and 100 parts by weight of water, which is a low viscosity additive with a flow value of 330 mm.

Thus, using a low-viscosity mortar allows for kneading in a general-purpose cement mixer and temporary storage in an agitator, as well as permits long-distance transportation (feeding under pressure) at a stable rate through a hose. Besides, the additive is a low-viscosity material obtained by dispersing a clay mineral in water with the help of a dispersing agent and permits stable long-distance pressurized supply of a fixed volume through a hose. Thus, the low-viscosity mortar and the additive are pressure fed through a hose from ground level up to the vicinity of the pipe fabrication machine inside the existing pipeline and mixed in a fixed proportion immediately prior to being injected into the space between the existing pipeline and the spiral wound pipe, which enables reliable injection of a fixed volume of the thickened mortar into the space.

The present invention is characterized by the fact that, in the method for rehabilitating an existing pipeline described above, an intermediate tank and a booster pump are installed inside the pipeline and the low-viscosity mortar is supplied through piping from ground level to the intermediate tank, after which the low-viscosity mortar is supplied by the booster pump from the intermediate tank to the pump equipped with the kneading section.

According to the inventive method for rehabilitating an existing pipeline, low-viscosity mortar is pressure fed through piping from ground level to the intermediate tank, pressure fed to the vicinity of the pipe fabrication machine by the booster pump, and then injected into the space after being turned into high-viscosity mortar by kneading the low-viscosity mortar with the viscosity-increasing additive prior to injection into the space between the pipeline and the spiral wound pipe, which permits reliable injection of the high-viscosity mortar into the space at a fixed discharge rate even in case of significant elevation differences between ground level and the pipe fabrication machine.

In addition, the fact that manual transportation is rendered unnecessary allows for a man-hour reduction and labor savings. Furthermore, the method permits rehabilitation of small-diameter non-man-entry pipelines.

The present invention is characterized by the fact that the method for rehabilitating an existing pipeline described above comprises a level sensor used for detecting the level of the low-viscosity mortar present in the intermediate tank, and supply control means for controlling the supply/cessation of supply of the low-viscosity mortar from ground level to the intermediate tank based on the output of the level sensor. In such a case, the liquid level sensor may be represented by upper/lower limit sensors, with the signals outputted from such upper/lower limit sensors used to control the delivery pump in such a manner that low-viscosity mortar is supplied to the intermediate tank after reaching the lower limit and the delivery pump at ground level is stopped after reaching the upper limit, thereby controlling the supply/cessation of supply of the low-viscosity mortar from ground level to the intermediate tank.

The method for rehabilitating an existing pipeline described above may be adapted by installing an intermediate tank for additives and a booster pump for additives in the pipeline, supplying the additive from ground level to the intermediate tank for additives through additive piping, and then supplying the additive from the intermediate tank for additives to the pump equipped with the kneading section with the help of the booster pump for additives. In addition, in such a case, an additive level sensor used for detecting the level of the additive present in the intermediate tank for additives and additive supply control means used for controlling the supply/cessation of supply of the additive from ground level to the intermediate tank for additives based on the output of the additive level sensor may be provided as well.

The present invention is characterized by the fact that, in the piping supplying the low-viscosity mortar under the method for rehabilitating an existing pipeline described above, a flow meter and a shutoff device are installed in the stage preceding the kneading section, and, after a preset volume of the low-viscosity mortar and the additive is supplied to the kneading section, the supply of the low-viscosity mortar is shut off by the shutoff device and a high-viscosity mortar is produced by mixing the low-viscosity mortar and the additive in the kneading section, with the high-viscosity mortar injected by the pump equipped with the kneading section into the space. In this case, the additive may be supplied through the additive piping from ground level and, in the additive piping, in the stage preceding the kneading section, there may be installed an additive flow meter and an additive shutoff device, and, after a preset volume of the low-viscosity mortar and the additive is supplied to the kneading section, the supply of the additive is shut off by the additive shutoff device and a high-viscosity mortar is produced by mixing the low-viscosity mortar and the additive in the kneading section, with the high-viscosity mortar injected by the pump equipped with the kneading section into the space.

According to the inventive method for rehabilitating an existing pipeline, after a preset volume of the low-viscosity mortar and the additive is supplied to the kneading section, its supply is shut off by the shutoff device, thereby allowing for the low-viscosity mortar and the additive to be mixed in the kneading section in a fixed proportion at all times and permitting production of a high-viscosity mortar of stable viscosity. Accordingly, a fixed volume of the high-viscosity mortar can be reliably injected into the space even in case of significant elevation differences between ground level and the pipe fabrication machine. In addition, the fact that manual transportation is rendered unnecessary allows for a man-hour reduction and labor savings.

In addition, the present invention is characterized by adopting a system, in which when the flow meter reaches a predetermined value, the shutoff device is actuated to automatically shut off the supply of the low-viscosity mortar to the kneading section and as the kneading process begins, the origin of the flow meter is set in preparation for supplying the next batch of the low-viscosity mortar to the kneading section. In such a case, the additive shutoff device may be actuated to automatically shut off the supply of the additive to the kneading section when the additive flow meter reaches a predetermined value and, as the kneading process begins, the additive flow meter may be reset to the origin in preparation for supplying the next batch of additive to the kneading section.

Furthermore, the inventive method for rehabilitating an existing pipeline permits a reduction in work force. In addition, since the supply of the low-viscosity mortar and the additive to the kneading section is shut off automatically, the method permits rehabilitation of small-diameter non-man-entry pipelines. In such a case, the automatic supply shutoff can be implemented, for instance, based on acquisition of a signal outputted from the flow meter.

Furthermore, the present invention is characterized by the fact that the shutoff device is a pinch valve or a squeeze-off tool and that the use of a pinch valve or a squeeze-off tool that squeezes off the hose as the shutoff device prevents incomplete shutoff associated with cement curing inside the low-viscosity mortar shutoff device and makes it possible to avoid problems.

### BRIEF DESCRIPTION OF THE DRAWINGS

FIG. 1 is an explanatory diagram illustrating the relative arrangement of the various pieces of equipment used in the working of the rehabilitation method in a first embodiment of the present invention.

FIG. 2 is an explanatory diagram of the mortar kneading/supplying pump.

FIG. 3A is a side view schematically illustrating the configuration of the mixing/charging pump used in the method for rehabilitating an existing pipeline of the present invention.

FIG. 3B is a plan view schematically illustrating the configuration of the mixing/charging pump used in the method for rehabilitating an existing pipeline of the present invention.

FIG. 4 is a side view schematically illustrating another example of the screw mixer forming part of the mixing/charging pump.

FIG. 5 is a side view schematically illustrating another example of the mortar kneading/supplying pump used in the existing pipeline rehabilitation method of the present invention.

FIG. 6 is an explanatory diagram illustrating the relative arrangement of the various pieces of equipment used in the working of the rehabilitation method in a second embodiment of the present invention.

FIG. 7 is an explanatory diagram of the intermediate tanks.

FIG. 8 is an explanatory diagram illustrating the relative arrangement of the various pieces of equipment used in the working of the rehabilitation method in a third embodiment of the present invention.

FIG. 9 is a side view schematically illustrating an example of the mortar kneading/supplying pump used in the existing pipeline rehabilitation method in the third embodiment of the present invention.

FIG. 10 is an explanatory diagram of the method for rehabilitating an existing pipeline using the method of liner pipe fabrication with simultaneous grouting, with the pipe fabrication machine viewed from the front.

FIG. 11 is an explanatory diagram of the method for rehabilitating an existing pipeline using the method of liner pipe fabrication with simultaneous grouting, in which part of the pipe fabrication machine is shown in an oblique partially cutaway view.

FIG. 12A is a cross-sectional view of the profile strip used in the method of liner pipe fabrication with simultaneous grouting.

FIG. 12B is a cross-sectional view of another example of the profile strip used in the method of liner pipe fabrication with simultaneous grouting.

FIG. 13 is a cross-sectional view illustrating the construction of the main portion of the interlocking mechanism section of the pipe fabrication machine of FIG. 10.

### DESCRIPTION OF THE PREFERRED EMBODIMENTS

Below, embodiments of the present invention are explained by referring to drawings.

### Embodiment 1

The method for rehabilitating an existing pipeline used in this embodiment is appropriate for use in the method of liner pipe fabrication with simultaneous grouting, i.e. in a method for rehabilitating existing pipelines, in which a pipe is fabricated with the help of a pipe fabrication machine on the interior surface of an existing pipeline from an elongated band-shaped profile strip having interlocking sections formed along its two lateral margins by spirally interlocking the interlocking sections while injecting high-viscosity mortar into the space between the existing pipeline and the newly formed spiral wound pipe.

Namely, a high-flow low-viscosity mortar (called “Slurry A” below) is pressure fed through piping from ground level to the pipe fabrication machine and is turned into a high-viscosity mortar by adding an additive that increases the viscosity of the mortar and is supplied through separate piping (called “Slurry B” below) prior to injection into the space, whereupon the high-viscosity mortar is injected into the space between the existing pipeline and the spiral wound pipe.

Slurry A contains a cement (Portland cements such as ordinary Portland cement, high early strength Portland cement, ultra high-early-strength Portland cement, and moderate heat Portland cement, etc., and blended cements such as blast furnace cement, silica cement, etc.) and water as essential components, and in addition, if necessary,
admixtures (flyash, blast-furnace slag, silica fumes, etc.);
expansion materials (CaO, 3CaO.Al₂O₃.CaSO₄, and 6CaO.Al₂O₃.SO₃, etc.);
expansion agents (aluminum powder, silicon powder, etc.);
water-reducing agents (ligninsulfonic acid, naphthalenesulfonic acid, melaminesulfonic acid, polycarboxylic acid, and aminosulfonic acid-based, etc);
segregation-reducing agents (methylcellulose, polyvinyl alcohol, hydroxyl alcohol, sodium polyacrylate, and polyacrylamide-based);
aggregates (silica sand, river sand, stone powder, etc.); and
polymer dispersions (acrylic, vinyl acetate, ethylene/vinyl acetate, and SBR-based, etc.). Slurry A, which is produced by kneading the above, is a high-flow low-viscosity mortar with a flow value of not less than 200 mm.

Slurry B, which contains a clay mineral (bentonite, metakaolin, attapulgite, etc.), a dispersing agent (inorganic phosphate-based, sulfuric acid ester salts of cyclic compounds, etc.), and water, also is an additive with a flow value of not less than 200 mm.

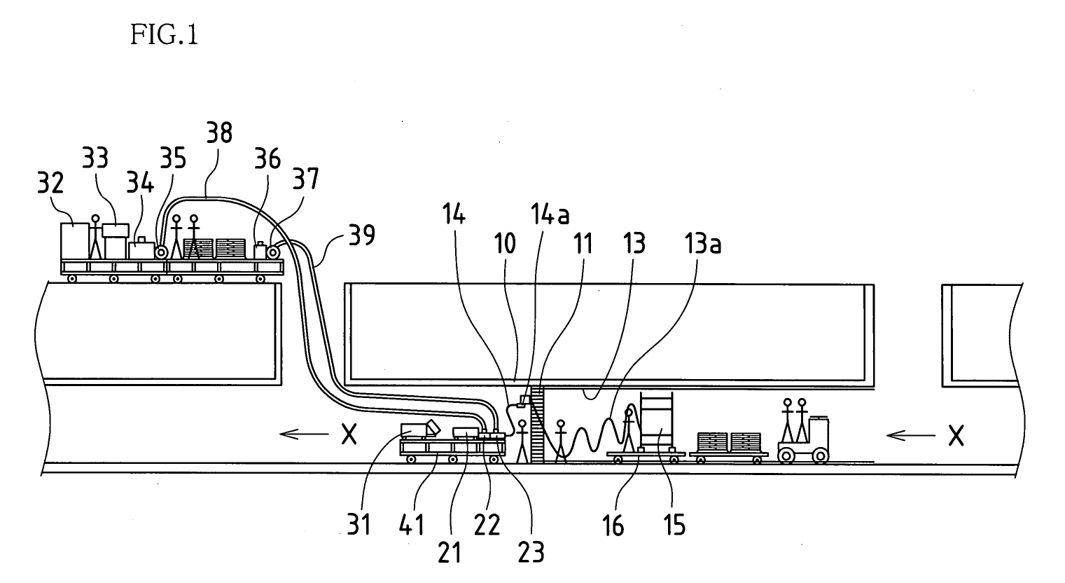

FIG. 1 illustrates the relative arrangement of the various pieces of equipment used in the working of the rehabilitation method of the present embodiment.

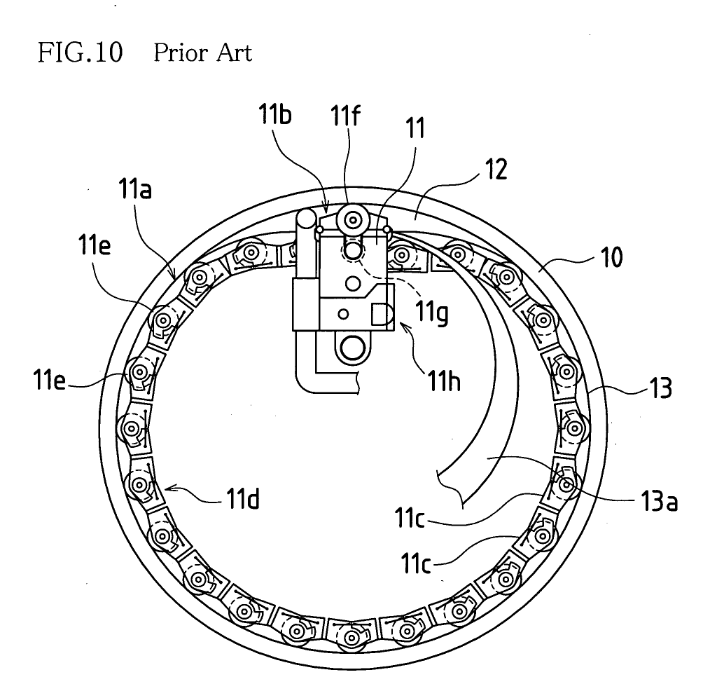

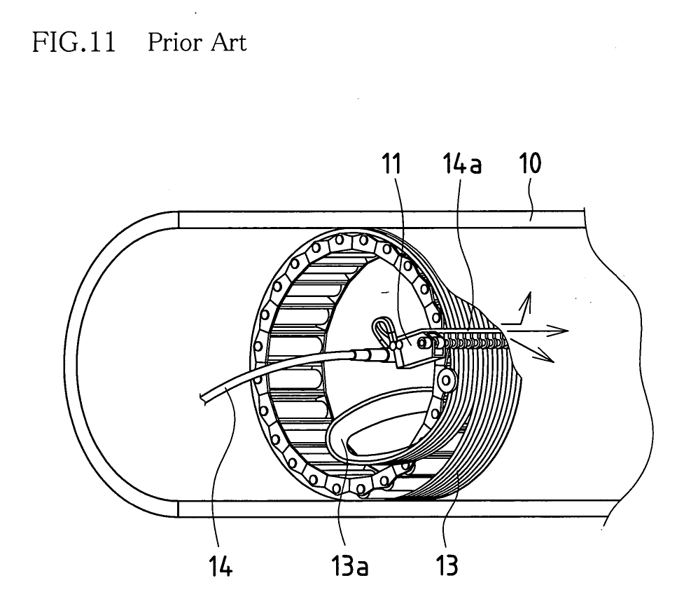

In the figure, reference numeral 10 denotes an existing pipeline, 11 denotes a pipe fabrication machine, 13 denotes a spiral wound pipe, 13a denotes a profile strip, 14 denotes a supply hose, and 14a denotes an injection nozzle, and because the configuration of the devices is identical to the conventional configuration illustrated in FIG. 10 and FIG. 11, they are assigned the same reference numerals. In addition, in the figure, reference numeral 15 denotes a profile strip feeder, which in the present embodiment is placed on a carriage 16 for movement through the existing pipeline 10 together with the pipe fabrication machine 11 in the direction of formation of the spiral wound pipe (indicated by arrow X in the figure). However, the profile strip feeder 15 can be installed at ground level as well.

On the other hand, a mortar kneading/supplying pump 21 and a hydraulic power unit 31 used for hydraulically driving the pipe fabrication machine 11, which are installed on a carriage 41, are located opposite the profile strip feeder 15, with the pipe fabrication machine 11 positioned in between.

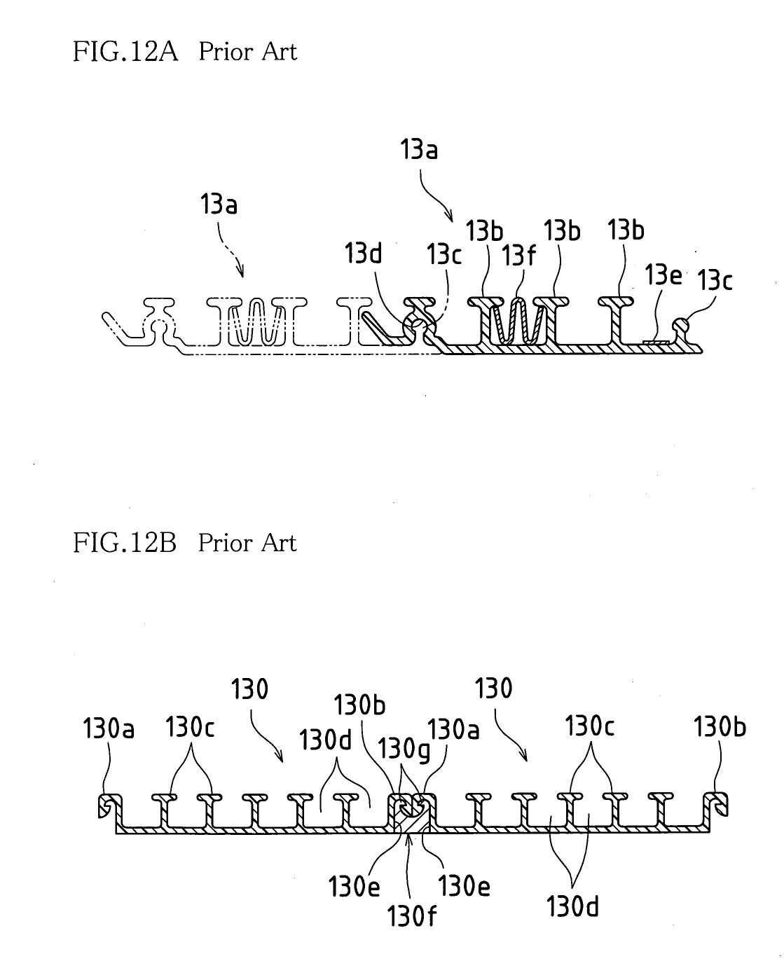

Here, as shown in FIG. 12A, the profile strip 13a is a band-shaped member molded in the form of an elongated band out of synthetic resin (e.g. rigid polyvinyl chloride, polyethylene, polypropylene, etc.), with a plurality of ribs 13b-13b formed in the longitudinal direction. In addition, interlocking protrusions 13c and interlocking recesses 13d, which are engaged by mutually overlapping from the inside and outside, are formed in the longitudinal direction along its two lateral margins of the profile strip 13a, respectively, and sealing members 13e, which are used to ensure leak-tightness, are provided in the vicinity of the interlocking protrusions 13c. The sealing members 13e are formed by extrusion of elastomers or other soft elastic materials simultaneously with the profile strip 13a. Moreover, the sealing members 13e may be formed by coating with hot-melt adhesives or solvent adhesives.

The thus constructed profile strip 13a, which has reinforcing members 13f inserted between the two ribs 13b, 13b, is taken up on the profile strip feeder 15.

It should be noted that the present invention is not limited to the above-described structure, and a two-piece type in which a main member 130 and a fitting member 130f are combined, as shown in FIG. 12B, can be used. The main member 130 of this profile strip has protrusions 130c and grooves 130d, has joining portions 130a and 130b formed at both ends thereof, and has fitting grooves 130e formed in the joining portions 130a and 130b. The fitting member 130f has fitting protrusions 130g that are elastically fitted into the fitting grooves 130e of the main member 130. Then, when joining, the fitting member 130f joins the main members 130 that are juxtaposed, straddling between the joining portions 130a and 130b.

As shown in FIG. 10, the pipe fabrication machine 11, which is a self-propelled pipe fabrication machine used to fabricate a liner pipe of a circular cross-section, comprises a forming frame 11a and an interlocking mechanism section 11b installed in the forming frame 11a.

The forming frame 11a is made up of a (freely bendable) linkage mechanism 11d, which has an annular construction composed of a plurality of mutually interconnected links 11c-11c, and guide rollers 11e-11e, which are rotatably supported by the links 11c of the linkage mechanism 11d.

The interlocking mechanism section 11b is composed of an outside roller 11f and an inside roller 11g, which nip the profile strip 13a from the outside and from the inside, and a hydraulic motor 11h, which drives the outside roller 11f and the inside roller 11g, and the like.

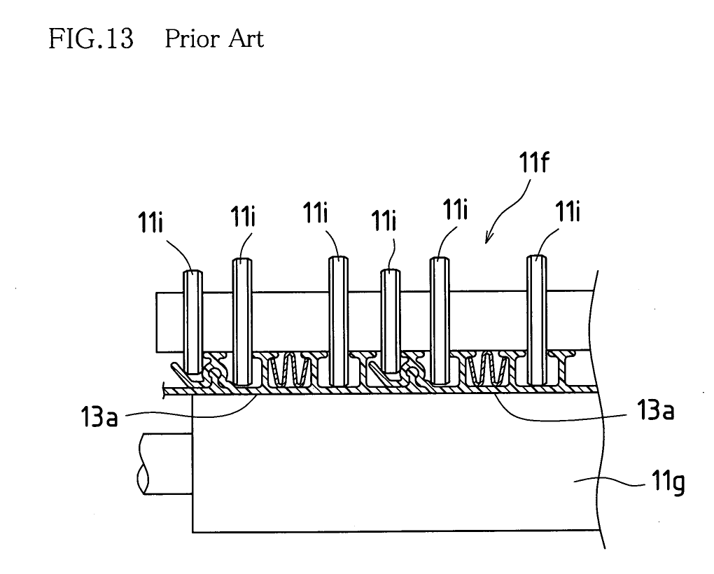

As shown in FIG. 13, the outside roller 11f is a fin-shaped roller, in which a plurality of flanges 11i-11i inserted between the ribs 13b of the profile strip 13a are provided on its outer peripheral surface, and the inside roller 11g is a roller with a flat external peripheral surface. It should be noted that the external peripheral surface of the inside roller 11g is preferably coated with rubber etc. imparting it with a high frictional resistance.

Due to the fact that the outside roller 11f and the inside roller 11g are interconnected through gear(s) (not shown) and the inside roller 11g is driven in rotation by a hydraulic motor 11h, the inside roller 11g and outside roller 11f rotate in mutually opposite directions. The rotation of the outside roller 11f and inside roller 11g causes the entire pipe fabrication machine 11 to revolve inside the existing pipeline 10 and advance forward while spirally winding the profile strip 13a and, at the same time, permits the interlocking protrusions 13c and interlocking recesses 13d of the mutually adjacent profile strips 13a, 13a to be mutually interlocked during its travel.

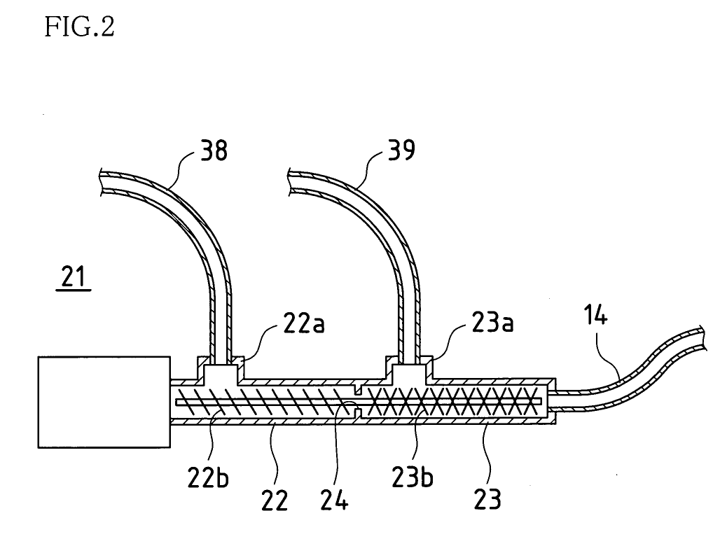

As shown in FIG. 2, the mortar kneading/supplying pump 21 comprises a fixed volume dispensing section 22, which extrudes fixed volumes of Slurry A (low-viscosity mortar), and a kneading section 23, in which Slurry A is kneaded in a fixed proportion with Slurry B used for increasing the viscosity of Slurry A, and the partition separating the fixed volume dispensing section 22 from the kneading section 23 is provided with an intake opening 24, which is used for extruding a fixed volume of Slurry A from the fixed volume dispensing section 22 into the kneading section 23. Moreover, an intake port for Slurry A 22a is provided in the upper portion of the fixed volume dispensing section 22 and an intake port for Slurry B 23a is provided in the upper portion of the kneading section 23. Furthermore, the rear-end section of a supply hose 14, which has an injection nozzle 14a (see FIG. 1) attached to its tip, is connected to the front side of the kneading section 23. The mortar kneading/supplying pump 21 is a single-screw extrusion molding machine, in which Slurry A, as well as Slurry A and Slurry B, are uniformly kneaded with the help of screws 22b and 23b provided in the fixed volume dispensing section 22 and kneading section 23.

On the other hand, a generator 32 supplying electric power to the hydraulic power unit 31, a mortar mixer 33 (an ordinary cement mixer) used for kneading Slurry A, an agitator 34 used for temporarily storing kneaded Slurry A, a Slurry A pump 35 used for pressure feeding Slurry A to the fixed volume dispensing section 22 of the mortar kneading/supplying pump 21, a tank for Slurry B 36 used for kneading and temporarily storing Slurry B, and a Slurry B pump 37 used for pressure feeding Slurry B to the kneading section 23 of the mortar kneading/supplying pump 21 are installed at ground level, the intake port for Slurry A 22a of the fixed volume dispensing section 22 of the mortar kneading/supplying pump 21 and the Slurry A pump 35 are connected through a Slurry A hose 38, and the intake port for Slurry B 23a of the kneading section 23 of the mortar kneading/supplying pump 21 and the Slurry B pump 37 are connected through a Slurry B hose 39.

In other words, at ground level, Slurry A of the composition described above is kneaded by the mortar mixer 33 and temporarily stored in the agitator 34 as a high-flow low-viscosity mortar with a flow value of not more than 200 mm. Then, the Slurry A pump 35 pressure feeds the kneaded Slurry A to the fixed volume dispensing section 22 of the mortar kneading/supplying pump 21 through the Slurry A hose 38. Simultaneously, Slurry B of the composition described above is kneaded and temporarily stored in the tank for Slurry B 36, after which the kneaded Slurry B is pressure fed by the Slurry B pump 37 to the kneading section 23 of the mortar kneading/supplying pump 21 through the Slurry B hose 39.

Then, Slurry A supplied to the fixed volume dispensing section 22 is uniformly kneaded there and, by adding Slurry B, i.e. the additive, in the subsequent kneading section 23 and kneading Slurry A with Slurry B in a fixed proportion, the mortar, i.e. Slurry A, is thickened to a flow value of less than 200 mm, producing a high-viscosity mortar, with said high-viscosity mortar injected through the injection nozzle 14a of the supply hose 14 into the space 12 (see FIG. 10) between the existing pipeline 10 and the spiral wound pipe 13.

It should be noted that while the generator 32, mortar mixer 33, agitator 34, Slurry A pump 35, tank for Slurry B 36, and Slurry B pump 37 are located at ground level in the embodiment described above, in some cases they may be located in front of the hydraulic power unit 31 (on the left in FIG. 1) in the existing pipeline 10 or placed on a carriage etc. so as to permit transportation together with the pipe fabrication machine 11.

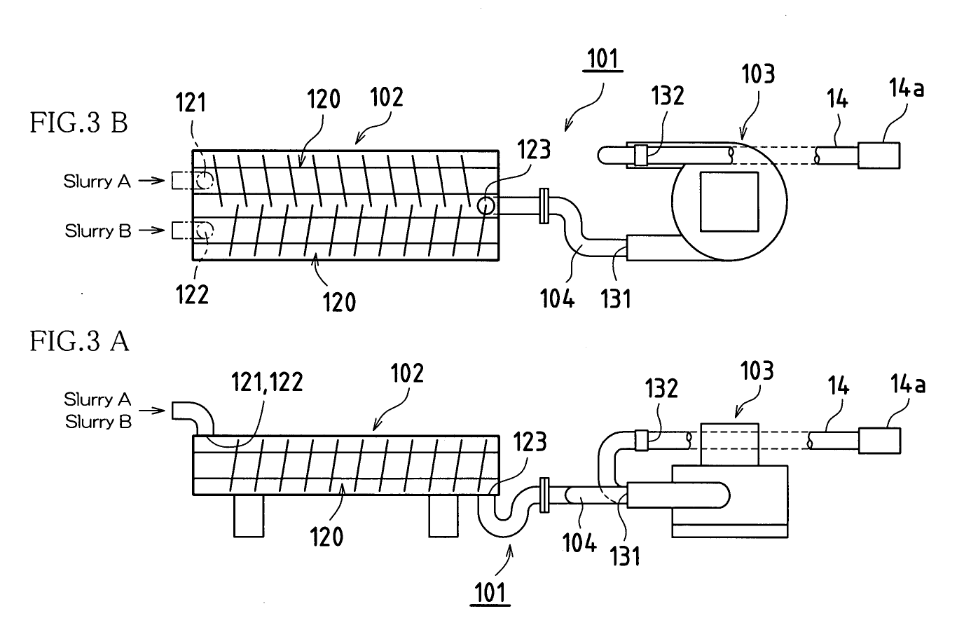

Next, another example of the mortar injection method is explained by referring to FIG. 3A and FIG. 3B.

First of all, in this example, the mixing/charging pump 101 shown in FIG. 3A and FIG. 3 B, which is equipped with a kneading section, is located in the vicinity of the pipe fabrication machine 11, and thickened high-viscosity mortar is injected by the mixing/charging pump 101 into the space 12 between the existing pipeline 10 and the spiral wound pipe 13.

The mixing/charging pump 101 shown in FIG. 3A and FIG. 3B comprises a twin-screw mixer 102, which uniformly kneads the additive (Slurry B) with the high-flow low-viscosity mortar (Slurry A) pressure fed from ground level, and a squeeze pump 103, which is used to pressure feed the thickened high-viscosity mortar uniformly mixed by the twin-screw mixer 102 to the injection nozzle 14a.

After placing the twin-screw mixer 102 and squeeze pump 103 on a carriage (not shown), they are brought inside the existing pipeline and positioned in the vicinity of the pipe fabrication machine 11.

The Slurry A hose 38 and the Slurry B hose 39 (see FIG. 1) originating at ground level are respectively connected to the two material input ports 121 and 122 of the twin-screw mixer 102. Moreover, an extrusion port 123 of the twin-screw mixer 102 is connected to the suction port 131 of the squeeze pump 103 through a hose connector 104. It should be noted that the configuration of the respective electric motors driving the twin-screw mixer 102 and squeeze pump 103 is not shown in FIG. 3A and FIG. 3B.

The twin-screw mixer 102 is a semi-batch mixer with twin screws, wherein Slurry A and Slurry B, which are supplied, respectively, to the two material input ports 121 and 122, are continuously propelled forward (towards the extrusion port 123) while being uniformly kneaded by the twin screws 120, 120. Due to the fact that the twin-screw mixer 102 kneads Slurry A and Slurry B in this manner in a fixed proportion ([Slurry A][Slurry B]=[4-15][1], volume ratio), the mortar, i.e. Slurry A, is thickened to a flow value of less than 200 mm.

The squeeze pump 103 comprises, for instance, an elastically resilient nearly horizontal U-shaped elastic tube (not shown) and pressure rollers (not shown) applying constant pressure to a certain portion (part) of the elastic tube so as to keep it in a closed state, and is adapted to pressure feed the fluid in the elastic tube, i.e. the high-viscosity mortar thickened in the twin-screw mixer 102, in a single direction by changing the location of compression (nipping) of the elastic tube using the driven rotation of the pressure rollers.

In addition, by connecting the supply hose 14 to the discharge port 132 of the above squeeze pump 103, the high-viscosity mortar with a flow value of less than 200 mm can be injected from the injection nozzle 14a in the tip of the supply hose into the space 12 (see FIG. 10) between the existing pipeline 10 and the spiral wound pipe 13.

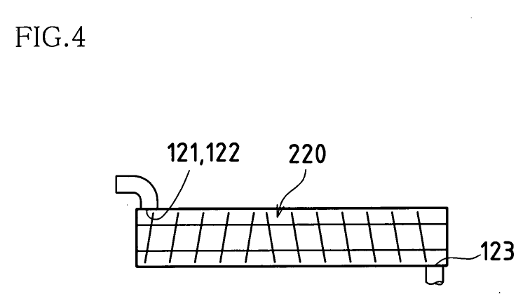

It should be noted that while the blades of the screw 120 in the twin-screw mixer 102 illustrated in FIGS. 3A and 3B are oriented constantly in the extrusion direction, using screw 220 shown in FIG. 4, in which blades located in the vicinity of the material input ports 121, 122 are oriented in opposite directions, improves the degree of kneading and, as a result, makes it possible to mix Slurry A and Slurry B even more uniformly. In addition, the screw mixer is not limited to twin-screw mixers and may be a multi-screw mixer with three or more screws.

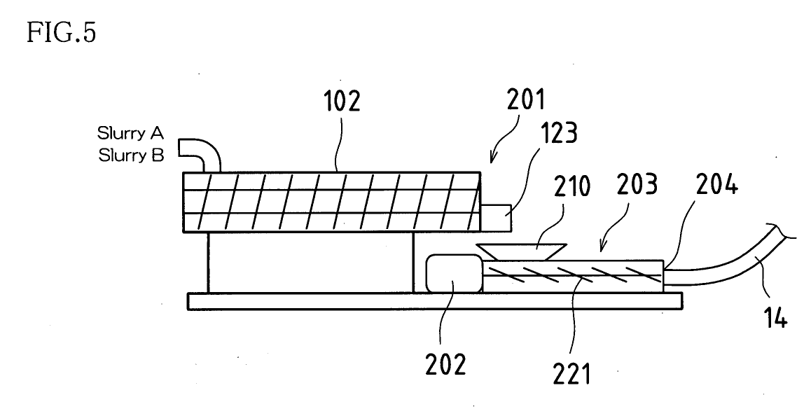

Next, a different method for injecting mortar is explained by referring to FIG. 5.

In a mixing/charging pump 201 illustrated in FIG. 5, the mixer 102 has the same construction as in FIG. 3A and FIG. 3B, i.e. it has a construction, in which high-viscosity mortar extruded from the extrusion port 123 of the mixer 102 is discharged into a hopper 210 of a snake pump 203.

The snake pump 203 is adapted to unidirectionally pressure feed the high-viscosity mortar forward using a helical screw 221 driven by an electric motor 202.

In addition, by connecting the supply hose 14 to a discharge port 204 of the snake pump 203, the high-viscosity mortar with a flow value of less than 200 mm can be injected from the injection nozzle 14a in the tip of the supply hose 14 into the space 12 (see FIG. 10) between the existing pipeline 10 and the spiral wound pipe 13.

### Embodiment 2

According to the method for rehabilitating an existing pipeline of the present embodiment, in the method for rehabilitating an existing pipeline of Embodiment 1 described above, a high-flow low-viscosity mortar (called “Slurry A” below) is pressure fed through piping from ground level to an intermediate tank and then pressure fed by a booster pump to a pump equipped with a kneading section and, at the same time, an additive that increases the viscosity of the mortar (called “Slurry B” below) is separately pressure fed from ground level to an intermediate tank for additives through additive piping and is then supplied to the pump equipped with the kneading section by a booster pump for additives, thereby producing a high-viscosity mortar, with said high-viscosity mortar injected into the space between the existing pipeline and the spiral wound pipe.

Here, the compositions of Slurry A and Slurry B are similar to those described in Embodiment 1.

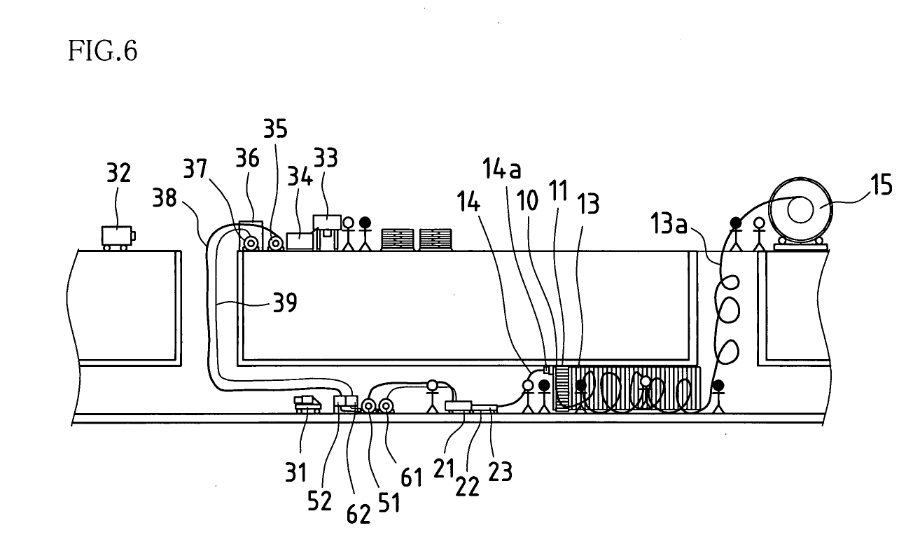

FIG. 6 illustrates the relative arrangement of the various pieces of equipment used in the working of the rehabilitation method of the present embodiment.

In the figure, reference numeral 10 denotes an existing pipeline, 11 denotes a pipe fabrication machine, 13 denotes a spiral wound pipe, 13a denotes a profile strip, 14 denotes a supply hose, and 14a denotes an injection nozzle, and because the configuration of the devices is identical to the conventional configuration illustrated in FIG. 10 through FIG. 13, they are assigned the same reference numerals. In addition, in the figure, reference numeral 15 is a profile strip feeder. Moreover, components identical to Embodiment 1 described above are assigned the same reference numerals and their detailed explanation is omitted.

On the other hand, a hydraulic power unit 31 hydraulically driving a mortar kneading/supplying pump 21 and the pipe fabrication machine 11, a booster pump for Slurry A 51, an intermediate tank for Slurry A 52, a booster pump for Slurry B 61, and an intermediate tank for Slurry B 62 are located opposite the profile strip feeder 15, with the pipe fabrication machine 11 located in between.

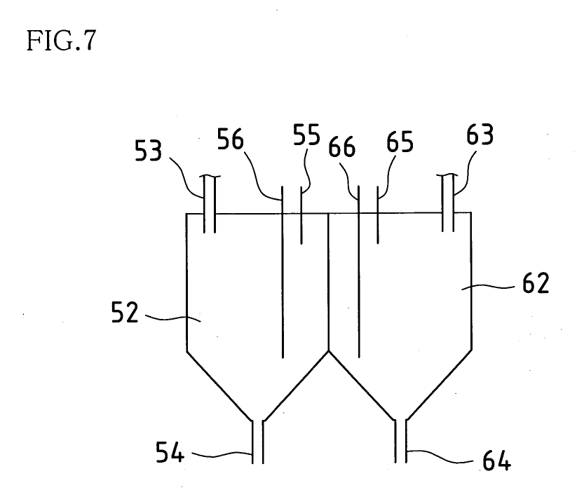

As shown in FIG. 7, the intermediate tank for Slurry A 52 is adapted such that Slurry A enters through an intermediate intake port for Slurry A 53 and the booster pump for Slurry A 51 discharges said Slurry A from an intermediate discharge port for Slurry A 54, supplying it to the intake port for Slurry A 22a of the fixed volume dispensing section 22 of the mortar kneading/supplying pump 21. Moreover, the level of Slurry A in the intermediate tank for Slurry A 52 is detected by an upper limit sensor for Slurry A 55 and a lower limit sensor for Slurry A 56. As a result, the supply/cessation of supply of Slurry A is controlled in such a manner that, at the upper limit level of Slurry A, a signal is outputted from the upper limit sensor for Slurry A 55 to the control panel of the Slurry A pump 35, and, based on this signal, the supply of Slurry A from ground level is stopped; and, at the lower limit level of Slurry A, a signal is outputted from the lower limit sensor for Slurry A 56 to the control panel of the Slurry A pump 35 and, based on this signal, the supply of Slurry A from ground level is started.

In case of the intermediate tank for Slurry B 62, Slurry B enters through an intermediate intake port for Slurry B 63 and the booster pump for Slurry B 61 discharges said Slurry B from an intermediate discharge port for Slurry B 64, supplying it to the intake port for Slurry B 23a of the kneading section 23 of the mortar kneading/supplying pump 21. Moreover, the level of Slurry B in the intermediate tank for Slurry B 62 is detected by an upper limit sensor for Slurry B 65 and a lower limit sensor for Slurry B 66. As a result, the supply/cessation of supply of Slurry B is controlled in such a manner that, at the upper limit level of Slurry B, a signal is outputted from the upper limit sensor for Slurry B 65 to the control panel of the Slurry B pump 37, and, based on this signal, the supply of Slurry B from ground level is stopped; and, at the lower limit level of Slurry B, a signal is outputted from the lower limit sensor for Slurry B 66 to the control panel of the Slurry B pump 37 and, based on this signal, the supply of Slurry B from ground level is started.

Therefore, even if the elevation difference between ground level and the existing pipeline 10 is large and the head pressure is high, the head pressure can be absorbed by the intermediate tanks, Slurry A and Slurry B can be fed to the kneading section 23 at a stable flow rate, and, moreover, the supply of Slurry A and Slurry B from ground level can be easily controlled using the level sensor.

A generator 32 used for supplying electric power to the hydraulic power unit 31, a mortar mixer 33 (an ordinary cement mixer) used for kneading Slurry A, an agitator 34, which temporarily stores kneaded Slurry A, a Slurry A pump 35 used for pressure feeding it to the intermediate tank for Slurry A 52, a tank for Slurry B 36 used for kneading and temporarily storing Slurry B, and a Slurry B pump 37 used for pressure feeding it to the intermediate tank for Slurry B 62 are located at ground level, with the Slurry A pump 35 connected to the intake port for Slurry A 53 of the intermediate tank for Slurry A through a Slurry A hose 38 and the Slurry B pump 37 connected to the intake port for Slurry B 63 of the intermediate tank for Slurry B 62 through a Slurry B hose 39.

In other words, at ground level, Slurry A of the composition described above is kneaded by the mortar mixer 33 and temporarily stored in the agitator 34 as a high-flow low-viscosity mortar with a flow value of not less than 200 mm. Then, the Slurry A pump 35 supplies the kneaded Slurry A to the intermediate tank for Slurry A 52 through the Slurry A hose 38, and the booster pump for Slurry A 51 pressure feeds it to the fixed volume dispensing section 22. At the same time, Slurry B of the composition described above is kneaded and temporarily stored in the tank for Slurry B 36, after which the kneaded Slurry B is supplied by the Slurry B pump 37 to the intermediate tank for Slurry B 62 through the Slurry B hose 39 and then pressure fed by the booster pump for Slurry B 61 to the kneading section 23 of the mortar kneading/supplying pump 21.

Then, Slurry A supplied to the fixed volume dispensing section 22 is uniformly kneaded there and, by adding Slurry B, i.e. the additive, in the subsequent kneading section 23 and mixing Slurry A with Slurry B in a fixed proportion, the mortar, i.e. Slurry A, is thickened to a flow value of less than 200 mm, producing a high-viscosity mortar, with said high-viscosity mortar injected through the injection nozzle 14a of the supply hose 14 into the space 12 (see FIG. 10) between the existing pipeline 10 and the spiral wound pipe 13.

It should be noted that while the generator 32, the mortar mixer 33, the agitator 34, the Slurry A pump 35, the tank for Slurry B 36, and the Slurry B pump 37 are located at ground level in the embodiment described above, in some cases they may be located in front of the hydraulic power unit 31 (on the left in FIG. 6) in the existing pipeline 10 or placed on a carriage etc. so as to permit transportation together with the pipe fabrication machine 11.

Moreover, in the embodiment above Slurry B is pressure fed to the kneading section 23 of the mortar kneading/supplying pump 21 through the Slurry B hose 39, but if the existing pipeline 10 has a large pipe diameter, the required amount of Slurry B can be placed in a container and introduced directly into the intermediate tank for Slurry B 62.

The mortar injection method is the same as in Embodiment 1 described above.

### Embodiment 3

According to the method for rehabilitating an existing pipeline of the present embodiment, in the method for rehabilitating an existing pipeline of Embodiment 1 described above, a flow meter and a shutoff device are installed in the stage preceding the kneading section and, after supplying a preset volume of the low-viscosity mortar and the additive to the kneading section, the supply is shut off by the shutoff device and the low-viscosity mortar is mixed with the additive in the kneading section, producing a high-viscosity mortar, with said high-viscosity mortar injected into the space between the existing pipeline and the spiral wound pipe.

Furthermore, the method uses a system, in which the flow meter is set to the desired value and, when the flow rate of the low-viscosity mortar and the additive reaches the preset value, the shutoff device is actuated to automatically shut off the supply of the low-viscosity mortar and the additive to the kneading section and, as the kneading process starts in the kneading section and a high-viscosity mortar is produced, the origin of the flow meter is set in preparation for supplying the next batch of the low-viscosity mortar and the additive to the kneading section.

Moreover, using a pinch valve or a squeeze-off tool that squeezes off the hose as the blocking device prevents incomplete blocking associated with cement curing and makes it possible to avoid problems.

Here, the compositions of Slurry A and Slurry B are similar to those described in Embodiment 1.

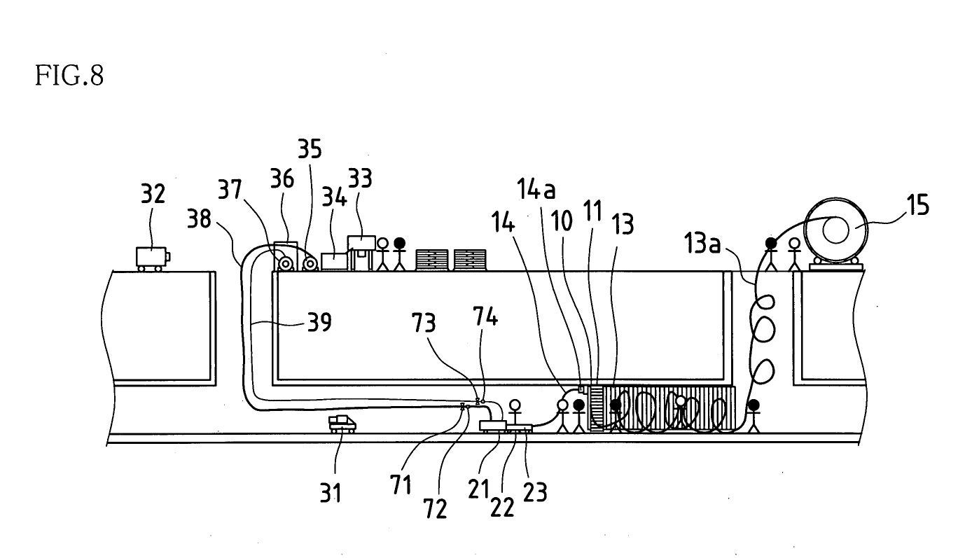

FIG. 8 illustrates the relative arrangement of the various pieces of equipment used in the working of the rehabilitation method of the present embodiment.

In the figure, reference numeral 10 denotes an existing pipeline, 11 denotes a pipe fabrication machine, 13 denotes a spiral wound pipe, 13a denotes a profile strip, 14 denotes a supply hose, and 14a denotes an injection nozzle, and because the configuration of the devices is identical to the conventional configuration illustrated in FIG. 10 through FIG. 13, they are assigned the same reference numerals. In addition, in the figure, reference numeral 15 is a profile strip feeder. Moreover, components identical to Embodiments 1 and 2 described above are assigned the same reference numerals and their detailed explanation is omitted.

A hydraulic power unit 31 hydraulically driving the mortar kneading/supplying pump 21 and the pipe fabrication machine 11, a Slurry A shutoff device 71, a Slurry A flow meter 72, a Slurry B shutoff device 73, and a Slurry B flow meter 74 are located opposite the profile strip feeder 15, with the pipe fabrication machine 11 located in between.

A generator 32 used for supplying electric power to the hydraulic power unit 31, a mortar mixer 33 (an ordinary cement mixer) used for kneading Slurry A, an agitator 34, which temporarily stores kneaded Slurry A, a Slurry A pump 35 used for pressure feeding it to the kneading section 23, a tank for Slurry B 36 used for kneading and temporarily storing Slurry B, and a Slurry B pump 37 used for pressure feeding it to the kneading section 23 are located at ground level, with the Slurry A pump 35 connected to the kneading section 23 through a Slurry A hose 38 and the Slurry B pump 37 connected to the kneading section 23 through a Slurry B hose 39.

In other words, at ground level, Slurry A of the composition described above is kneaded by the mortar mixer 33 and temporarily stored in the agitator 34 as a high-flow low-viscosity mortar with a flow value of not less than 200 mm. Then, the Slurry A pump 35 pressure feeds the kneaded Slurry A through the Slurry A hose 38 to the kneading section 23 via the Slurry A shutoff device 71 and the Slurry A flow meter 72. At the same time, Slurry B of the composition described above is kneaded and temporarily stored in the tank for Slurry B 36, whereupon the kneaded Slurry B is pressure fed by the Slurry B pump 37 through the Slurry B hose 39 to the kneading section 23 via the Slurry B shutoff device 73 and the Slurry B flow meter 74.

Thus, the quantity of delivered Slurry A and Slurry B can be controlled by the shutoff devices 71, 73 and flow meters 72, 74. Therefore, kneading Slurry A and Slurry B in a fixed proportion and thickening the mortar, i.e. Slurry A, to a flow value of less than 200 mm produces a high-viscosity mortar, and said high-viscosity mortar is injected into the space 12 (see FIG. 10) between the existing pipeline 10 and the spiral wound pipe 13 through the injection nozzle 14a of the supply hose 14.

Furthermore, acquiring signals outputted from the flow meters 72, 74 and activating the shutoff devices 71, 73 using air etc. as soon as a predetermined value is reached makes it possible to automatically control the supply of Slurry A and Slurry B to the kneading section 23. And, as the kneading process begins, the flow meters 72, 74 are reset to the origin in preparation for supplying the next batch of Slurry A and Slurry B to the kneading section 23.

Moreover, using a pinch valve or a squeeze-off tool that squeezes off the hose as the shutoff devices 71, 73 prevents incomplete shutoff associated with cement curing and makes it possible to avoid problems.

It should be noted that while the generator 32, mortar mixer 33, agitator 34, Slurry A pump 35, tank for Slurry B 36, and Slurry B pump 37 are located at ground level in the embodiment described above, in some cases they may be located in front of the hydraulic power unit 41 (on the left in FIG. 8) in the existing pipeline 10 or placed on a carriage etc. so as to permit transportation together with the pipe fabrication machine 11.

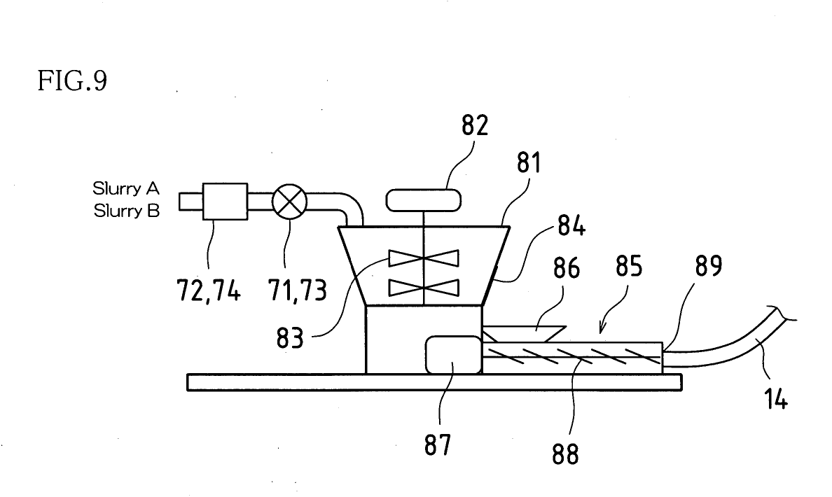

Next, a method for injecting mortar will be explained by referring to FIG. 9.

Slurry A and the Slurry B are supplied while measuring the supply rate of Slurry A and Slurry B supplied to a kneader 81 with the help of the flow meters 72 and 74 and, as soon as a predetermined volume is supplied, the supply of Slurry A and Slurry B is stopped by the shutoff devices 71, 73.

It should be noted that a control panel (not shown) is provided in the bottom portion of the kneader 81 and the kneader 81 is controlled by connecting the control panel to signal wires outputting signals to the ON/OFF controls of the kneader 81, to an accumulative counter, to the flow meters 72 and 74, and to the shutoff devices 71 and 73. Also, interconnecting each piece of equipment installed at ground level and the control panel using signal wires permits control to be exercised in such a manner that the Slurry A pump 35 and the Slurry B pump 37 are stopped when the quantity of the supplied Slurry A and Slurry B reaches a preset counter value.

After that, an electric agitator motor 82 of the kneader 81 is started and Slurry A and the Slurry B are mixed by the impellers 83, producing a high-viscosity mortar. When the mixing of Slurry A and Slurry B is over, the high-viscosity mortar is unloaded from a discharge gate 84 into a hopper 86 of a snake pump 85. Here, the feed ratio of Slurry A to Slurry B, i.e. Slurry A:SlurryB=4-15:1 (volume ratio). The unloading operation may be performed manually.

The snake pump 85 is adapted to unidirectionally pressure feed the high-viscosity mortar forward with the help of a helical screw 88 driven by an electric motor 87.

In addition, by connecting the supply hose 14 to the discharge port 89 of the above-mentioned snake pump 85, the high-viscosity mortar with a flow value of less than 200 mm can be injected from the injection nozzle 14a in the tip of the supply hose 14 into the space 12 (see FIG. 10) between the existing pipeline 10 and the spiral wound pipe 13.

It should be noted that the present invention can be reduced to practice in various other forms without departing from its spirit or main features. For this reason, to all intents and purposes, the embodiments described above are intended as mere illustrations and should not be interpreted in a restrictive sense. The scope of the present invention is defined by the claims and is not limited by the text of the specification in any way. Moreover, changes and modifications belonging to equivalents of the claims are within the scope of the present invention.

1. A method for rehabilitating an existing pipeline involving in fabricating a pipe on the interior surface of a pipeline from an elongated strip having interlocking sections formed along its two lateral margins by spirally interlocking the interlocking sections with the help of a pipe fabrication machine while injecting high-viscosity mortar into a space between the pipeline and the newly formed spiral wound pipe,
wherein a pump equipped with a kneading section is installed inside the pipeline and, along with supplying low-viscosity mortar through piping from ground level to the pump equipped with the kneading section, a viscosity-increasing additive is supplied to the kneading section, thereby producing a high-viscosity mortar, with the high-viscosity mortar injected into the space by the pump equipped with the kneading section.

2. The method for rehabilitating an existing pipeline according to claim 1, wherein the additive is supplied from ground level to the kneading section through additive piping.

3. The method for rehabilitating an existing pipeline according to claims 1 or 2, wherein the pump equipped with the kneading section comprises a zone used for extruding a fixed volume of the low-viscosity mortar, and a zone provided with an intake port for supplying the additive, in which the low-viscosity mortar is kneaded with the additive.

4. The method for rehabilitating an existing pipeline according to claims 1 or 2, wherein the pump equipped with the kneading section comprises a zone used for kneading the low-viscosity mortar with the additive and a zone, in which the kneaded high-viscosity mortar is pressure fed forward.

5. The method for rehabilitating an existing pipeline according to claims 1 or 2, wherein the pump equipped with the kneading section comprises a zone, in which the low-viscosity mortar and the additive are fed forward while being kneaded, and a zone, in which the high-viscosity mortar discharged from the preceding zone is sucked in and then pressure fed forward.

6. The method for rehabilitating an existing pipeline according to claims 1 or 2, wherein the flow value of the low-viscosity mortar is not less than 200 mm and the flow value of the high-viscosity mortar after the addition of the additive is less than 200 mm.

7. The method for rehabilitating an existing pipeline according to claim 1, wherein an intermediate tank and a booster pump are installed inside the pipeline and the low-viscosity mortar is supplied through piping from ground level to the intermediate tank, after which the low-viscosity mortar is supplied by the booster pump from the intermediate tank to the pump equipped with the kneading section.

8. The method for rehabilitating an existing pipeline according to claim 7, which comprises a level sensor used for detecting the level of the low-viscosity mortar present in the intermediate tank and supply control means for controlling the supply/cessation of supply of the low-viscosity mortar from ground level to the intermediate tank based on the output of the level sensor.

9. The method for rehabilitating an existing pipeline according to claim 8, wherein an intermediate tank for additives and a booster pump for additives are installed inside the pipeline and the additive is supplied through additive piping from ground level to the intermediate tank for additives, after which the additive is supplied by the booster pump for additives from the intermediate tank for additives to the pump equipped with the kneading section.

10. The method for rehabilitating an existing pipeline according to claim 9, which comprises an additive level sensor used for detecting the level of the additive present in the intermediate tank for additives and additive supply control means for controlling the supply/cessation of supply of the additive from ground level to the intermediate tank for additives based on the output of the additive level sensor.

11. The method for rehabilitating an existing pipeline according to claim 1, wherein in the piping supplying the low-viscosity mortar, a flow meter and a shutoff device are installed in the stage preceding the kneading section, and, after a preset volume of the low-viscosity mortar and the additive is supplied to the kneading section, the supply of the low-viscosity mortar is shut off by the shutoff device and a high-viscosity mortar is produced by mixing the low-viscosity mortar and the additive in the kneading section, with the high-viscosity mortar injected into the space by the pump equipped with the kneading section.

12. The method for rehabilitating an existing pipeline according to claim 11 using a system, in which the shutoff device is actuated to automatically shut off the supply of the low-viscosity mortar to the kneading section when the flow meter reaches a predetermined value and, as the kneading process begins, the origin of the flow meter is set in preparation for supplying the next batch of the low-viscosity mortar to the kneading section.

13. The method for rehabilitating an existing pipeline according to claim 12, wherein the additive is supplied through the additive piping from ground level to the kneading section and, in the additive piping, an additive flow meter and an additive shutoff device are installed in the stage preceding the kneading section, and, after a preset volume of the low-viscosity mortar and the additive is supplied to the kneading section, the supply of the additive is shut off by the additive shutoff device and a high-viscosity mortar is produced by mixing the low-viscosity mortar and the additive in the kneading section, with the high-viscosity mortar injected into the space by the pump equipped with the kneading section.

14. The method for rehabilitating an existing pipeline according to claim 13 using a system, in which the additive shutoff device is actuated to automatically shut off the supply of the additive to the kneading section when the additive flow meter reaches a predetermined value and, as the kneading process begins, the origin of the additive flow meter is set in preparation for supplying the next batch of the additive to the kneading section.

15. The method for rehabilitating an existing pipeline according to claim 11, wherein the shutoff device is a pinch valve.

16. The method for rehabilitating an existing pipeline according to claim 11, wherein the shutoff device is a squeeze-off tool.
